(19) United States
(12) Patent Application Publication
(10) Pub. No.: US 2003/0099087 A1
(43) Pub. Date: May 29, 2003

(54) Configuration of L-shaped computer case

(76) Inventor: Chuan-Ying Kao, Xin-Zhuang City (TW)

Correspondence Address: RABIN & CHAMPAGNE, P.C., Suite 500, 1101 14 Street, N.W., Washington, DC, 20005, US

(21) Appl. No.: 09/995,582

(22) Filed: Nov. 29, 2001

(51) Int. Cl. G06F 1/16

(52) U.S. Cl. 361/683

(57) ABSTRACT

A configuration of computer case has a first end to install power and signal connection interface as well as a second end as operation panel; the first end and said second end are integrated via a joint unit; the part from the first end to the joint unit and the part from the second end to the joint unit form an certain angle at the joint unit and thus actually assumes a L-shape. The size of the operation panel could be reduced yet with a larger volume. This L-shaped computer case can match LCD, which provides more available space besides case and monitor on a computer desk. Furthermore, the integration can even form a new mini triangle model of computer convenient to operate.

### FIELD OF INVENTION

The present invention relates to the configuration of personal computer (abbr. PC) case, especially the configuration of L-shaped PC case.

### BACKGROUND OF INVENTION

The configuration of traditional PC case consists of a hollow case in which there installs at least a mainboard. Said case has a back end which is a power and signal connection interface to install power and signal connection interface; it also has a front end as operation panel to install floppy disk or CD reading components such as CD-ROM, floppy disk drive, HDD, CD recorder, power switch, etc.

As illustrated in FIG. 1, traditional computer case (10) is a cuboid generally speaking with a width (L1) of 22 cm, a depth (L2) of 43 cm and a height (L3) of 45 cm. As known to most computer users, the reason why traditional computer case has to have such a huge volume lies in that: the mainboard must be installed on the sidewall (11) of the hollow case (10). And in order to avoid mainboard (12) from colliding with other components such as floppy disk drive, CD-ROM, CD recorder, etc. (13), the width (L1) of the case (10) much be broaden. Furthermore, in order to avoid mainboard (12) from colliding with the components on the back end such as power and signal sockets, the depth (L2) of the case (10) must also be increased. Especially when a user wants to install multiple CD-ROM, floppy disk drive or HDD to expand functions of the computer, he must consider increasing the volume of the case, otherwise, he has to install an additional case.

For a long period of time, the configuration of desktop PC case cannot reduce its volume and it is hard for both designers and manufacturers to overcome this technical dead spot. People have long been accustomed to the traditional configuration of computer case as a huge hollow cuboid. Moreover, in order to correctly plug in various plugs of power, monitor, etc. respectively, the computer user has no other choice but to fry hard in the mess of entangled signal and power wires within the case or to turn the back end of the case to the front, which is very inconvenient.

In a word, on the one hand, both designers and manufacturers are aware of the necessity to improve traditional computer case, but fail to fulfill it because of their well-established technical ideas. On the other hand, computer users have been so accustomed to the huge cuboid of traditional computer case that they think it a rather ultimate model hard to be improved. However, without doubt, such awkward traditional configuration needs to be improved.

### SUMMARY OF THE INVENTION

The primary object of the present invention is to provide a configuration of L-shaped computer case whose power and signal connection interface as well as operation panel can both face computer user as possible for convenient maintenance and installation.

A second object of the present invention is to provide a configuration of L-shaped computer case in which mainboard can be installed on its back wall instead of on its sidewall parallel with operation panel, thus providing a larger space inside the case and fully avoid mainboard from colliding with other components such as CD-ROM.

A third object of the present invention is to provide a configuration of L-shaped computer case that can reduce the length and width of the operation panel of computer case to a mini model yet with larger internal volume. The configuration of L-shaped computer case of the present invention is especially suitable for LCD, which enables more space available on the computer desk besides a case and a monitor.

Still another object of the present invention is to provide an integration of computer case and LCD to form a new mini triangle model of computer convenient to operate.

In order to achieve the above-mentioned objects, in the present invention, the configuration of computer case is totally changed. Moreover, the arrangement of various components installed in the case is also changed and thus provides larger space comparing with the traditional one. Users can install additional CD-ROM, floppy disk drive, HDD, CD recorder, power switch, etc. upon their needs. However, the cost of the hollow L-shaped computer case of the present invention remains almost the same as that of the traditional computer case.

The present invention especially changes the installation place of mainboard from its sidewall to its back wall. In other words, mainboard is installed parallel with operation panel instead of traditionally perpendicular to operation panel. Therefore, it can provide more available space inside the case and further avoid mainboard from colliding with other components such as CD-ROM.

The configuration of L-shaped computer case of the present invention comprises: a hollow case in which there installs at least a mainboard. Said case has a first end to install power and signal connection interface; it also has a second end as operation panel to install components such as CD-ROM, floppy disk drive, HDD, CD recorder, etc. This L-shaped computer case of the present invention specializes in that: said first end and second end are integrated via a joint unit. Moreover, the part from said first end to said joint unit and the part from said second end to said joint unit form a certain angle greatly different from the parallel front-and-back spatial relationship of the first and second end of the traditional configuration, thus the case actually assumes a L-shape. Of course, the joint uniting point of said joint unit to said first and second end can be embodied either as fixed joint unit or as bracket.

A better embodiment of the present invention is that: the angle formed by the part from said first end to said joint unit and the part from said second end to said joint unit keeps between 45˜135 degrees, which makes it possible for both power and signal connection interface and operation panel to face computer user for convenient maintenance and installation.

Another better embodiment of the present invention is that: between the first and second end of the case there also integrates a monitor, e.g., LCD, which makes them to form a new mini triangle model of computer.

### BRIEF DESCRIPTION OF DRAWINGS

The attached figures illustrate the preferred embodiment of the configuration of this L-shaped computer case.

FIG. 1 is a schematic perspective view of traditional computer case.

FIG. 2 is a schematic perspective view of the embodiment of the configuration of L-shaped computer case of the present invention.

FIG. 3 is a top view of FIG. 2 that further shows schematic of one possible spatial arrangement of LCD, keyboard and mouse on the computer desk.

FIG. 4 is similar to FIG. 3 but illustrates another embodiment.

FIG. 5 is a top view of the configuration of L-shaped computer case of the present invention that also shows LCD and keyboard.

FIG. 6 is a schematic perspective view of another embodiment of the present invention.

### DETAILED DESCRIPTION OF THE PREFERRED EMBODIMENT

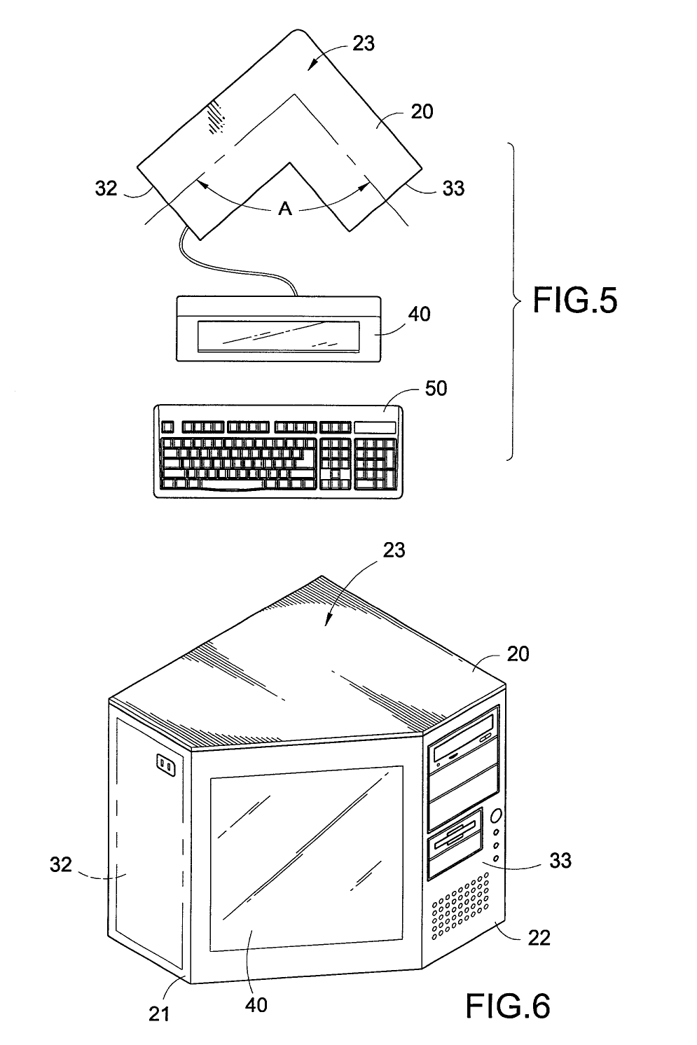

As illustrated in FIG. 2, the configuration of L-shaped computer case of the present invention comprises: a hollow case (20) in which there installs at least a mainboard (31). The case (20) has a first end (21) to install power and signal connection interface (32); it also has a second end (22) as operation panel (33) to install components such as CD-ROM, floppy disk drive, HDD, CD recorder, etc. The first end (21) and second end (22) of this case (20) are integrated via a joint unit (23). Moreover, the part from the first end (21) to the joint unit (23) and the part from the second end (22) to the joint unit (23), as illustrated in FIG. 5, form a certain angle (A) at the joint unit (23). A better embodiment of this angle (A) is to keep it between 45˜135 degrees, and therefore makes it possible for both power and signal connection interface (32) and operation panel (33) not to be installed at the back of the case (20), or in other words, make power and signal connection interface (32) and operation panel (33) face computer user for convenient maintenance and installation. The case (20) of the present invention actually assumes a L-shape, which is greatly different from the parallel front-and-back spatial relationship of the first and second end of the traditional configuration.

As illustrated in FIG. 2, in the present invention, the configuration of computer case is totally changed. Moreover, the arrangement of various components installed in the case is also changed and thus provides larger space comparing with the traditional one. The present invention especially changes the installation place of mainboard (31) from the sidewall to the back wall of the case (20). In other words, the mainboard (31) is installed in the part from said first end (21) to said joint unit (23) parallel, i.e. is not installed perpendicular to the operation panel (33), instead of traditionally design. Therefore, it can provide more available space inside the case (20) and further avoid the mainboard (31) from colliding with other components such as CD-ROM installed to operation panel (33). Users can install additional CD-ROM, floppy disk drive, HDD, CD recorder, power switch, etc. upon their needs. However, the cost of the hollow L-shaped computer case (20) of the present invention remains almost the same as that of the traditional computer case.

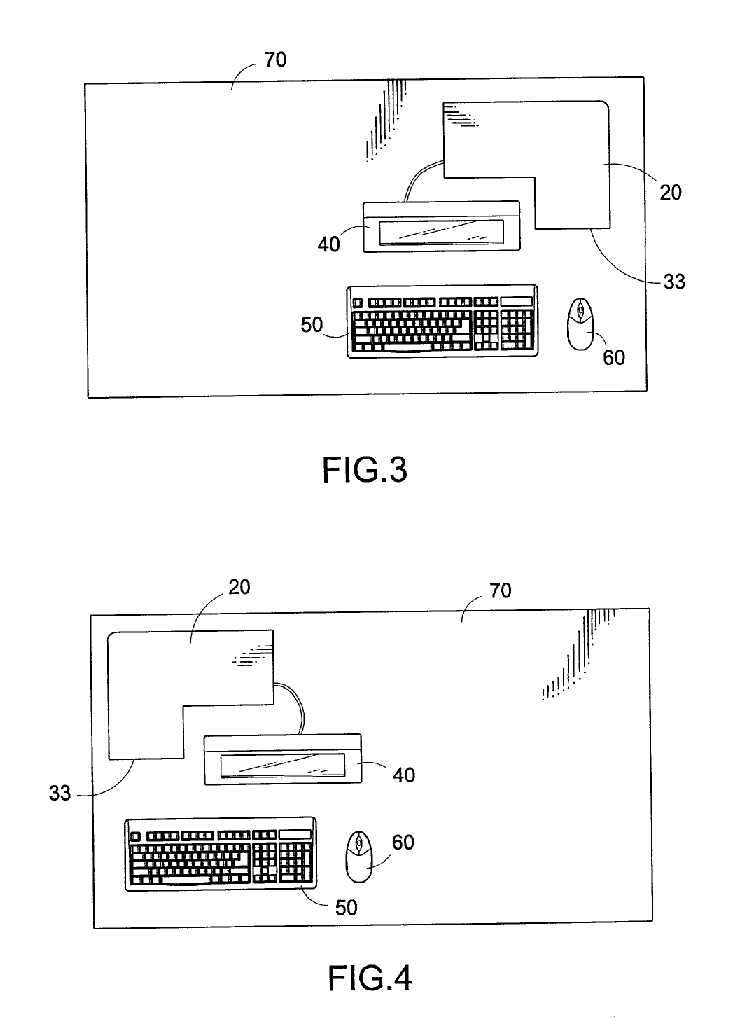

The present invention can reduce the volume of case (20). Moreover, on the basis that said operation panel (33) faces computer user, the case (20), as illustrated in FIG. 3, can be embodied as letting its first end (21) in which there installs power and signal connection interface extend leftwards from said joint unit (23) for right-handed computer user to put on the right corner of the computer desk (70). Correspondingly, another embodiment, as shown in FIG. 4, let its first end (21) extend rightwards from said joint unit (23) for left-handed computer user to put on the left corner of the computer desk (70). The present invention makes full use of the corner on the computer desk and has alternative choice for both right-handed and left-handed computer user to have more available space on the desk. The L-shaped computer case of the present invention especially matches LCD (40), and with keyboard (50) and mouse (60) in the front of operation panel (33), it can offer computer user larger available space besides case (20) and monitor (40) on the computer desk (70).

Another better embodiment of the present invention as illustrated in FIG. 6 is that: between the first end (21) and second end (22) of the case (20) there also contains a thin monitor (40), e.g., LCD, and furthermore, the monitor (40) and the hollow case (20) are integrated to form a new mini triangle model of computer.

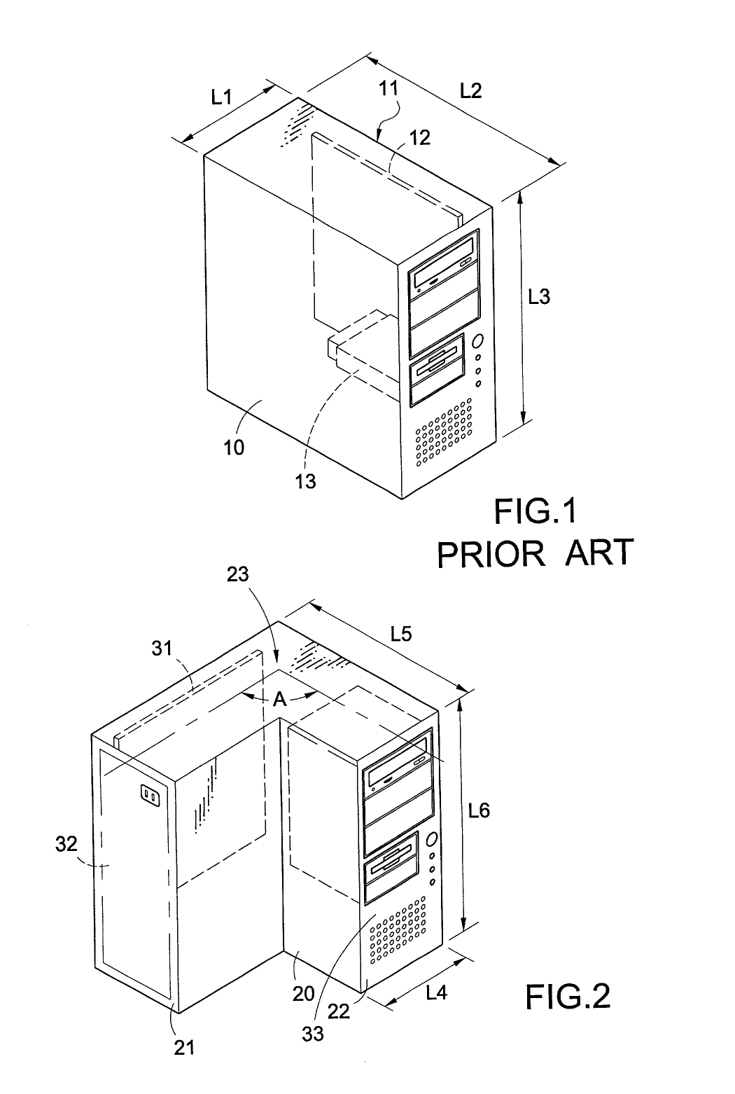

The present invention provides a configuration of L-shaped computer case that can reduce the size of the computer and reduce the width (L4) of case (20) to 18 cm, depth of operation panel (L5) to 35 cm and the height (L6) to 45 cm. Please refer to FIG. 1, compared with traditional computer case with a width (L1) of 22 cm, a depth (L2) of 43 cm and a height (L3) of 45 cm, the present invention greatly reduces the volume of computer case to only ⅚ of its original volume yet has larger inside space for the convenience of computer user.

The above-mentioned embodiments give evidence of the operability of this invention in details. However, if anyone masters this technology and invents a similar system that has difference either in appearance or in details, will be held legal responsibility of trespassing the originality and patent of this invention. Although certain preferred embodiment of the present invention has been shown and described in detail, it should be understood that various changes and modification might be made therein without departing from the scope of the appended claims.

What is claimed is as follows:

1. A configuration of L-shaped computer case comprising: a hollow case in which there installs at least a mainboard; said case has a first end to install power and signal connection interface as well as a second end as operation panel; said first end and said second end are integrated via a joint unit; the part from said first end to said joint unit and the part from said second end to said joint unit form an certain angle at the joint unit and thus actually assumes a L-shape.

2. The configuration of L-shaped computer case of claim 1, wherein the angle formed by the part from said first end to said joint unit and the part from said second end to said joint unit keeps is between 45˜135 degrees.

3. The configuration of L-shaped computer case of claim 1, further comprising a monitor between said first and second end to form a mini triangle model of computer.

4. The configuration of L-shaped computer case of claim 1, wherein the mainboard is not installed perpendicular to said operation panel but is installed between said first end and said joint unit.

5. The configuration of L-shaped computer case of claim 1, wherein said first end in which there installs power and signal connection interface extends leftwards from said joint unit on the basis that said operation panel of said case faces computer user.

6. The configuration of L-shaped computer case of claim 1, wherein said first end in which there installs power and signal connection interface extends rightwards from said joint unit on the basis that said operation panel of said case faces computer user.
